(19) United States
(12) Patent Application Publication
(10) Pub. No.: US 2020/0381986 A1
(43) Pub. Date: Dec. 3, 2020

(54) PERMANENT MAGNET GENERATOR AND METHODS OF MAKING AND USING THE SAME

(71) Applicant: Cardell Cannon, Macon, GA (US)

(72) Inventor: Cardell Cannon, Macon, GA (US)

(21) Appl. No.: 16/426,622

(22) Filed: May 30, 2019

(51) Int. Cl. H02K 21/02; H02K 1/27

(52) U.S. Cl. CPC H02K 21/025; H02K 1/27

(57) ABSTRACT

The present disclosure describes a permanent magnet generator and a method of making and using the generator to create an electrical output. The rotor system includes a series of permanent magnet elements that generate rotational energy to rotate a conductor within another permanent magnetic field.

The present disclosure describes a permanent magnetic generator and methods for generating electricity. More particularly, the disclosure describes a novel permanent magnet configuration that acts as a mechanical rotor assembly for spinning a conductor within a strong magnetic field. Still more particularly, the disclosure relates to a permanent magnet generator having highly predictable energy outputs. The disclosure still further relates to a system including the novel magnetic field configuration for providing physical rotation to armature conductors that are rotated within a second permanent magnetic field. Still further, the disclosure relates to the permanent magnetic generator including a housing, a cooling system, a braking system, a battery, and a commutator. The disclosure also relates to methods of making and using the novel permanent magnet configuration to produce energy.

### BACKGROUND

Permanent magnet generators (PMGs) have been around since the mid-1800s but have not found favor in the generation of large-scale power production because the magnetic flux available from historic permanent magnets had limited size and power output. In addition, PMGs have traditionally suffered from issues related to voltage control or reactive power production causing issues when operating on modern synchronized grids. Because PMGs have the advantages of simplicity and reliability, they have found continual use in areas where their output stability and reliability have been most valued, for example, in aircraft or other engines which require ignition redundancy for safety reasons. With the relatively recent development of rare earth magnets that permit a greatly increased field strength, modern PMGs are finding a variety of new uses including power production.

PMGs are basically made up of two parts, the rotor and the stator. One of the two, either the rotor or stator is also the armature. The armature is conductive and is the power producing component in the device and is responsible for directing the electromotive force that is created by the relative motion between the conductive material and the magnetic field. Because rare-earth metals are generally light and compact, in modern PMGs the magnets can be carried on the rotor, while the output windings can be carried by the stator. Alternatively, the stator/armature may be moved within the magnetic field, by for example, rotation. The permanent magnets induce an electric current by subjecting the output windings to changing magnetic fields. As the magnets and conducting wires move relative to one another, they generate electricity which, depending on the size, strength and speed of the magnets, can be sufficient to power a small home or a large power plant. Modern PMGs use a controller or sensor to control the electrical output from the coils on the conductor.

PMGs are mechanically simpler generators making them ideal for environments that prove difficult for traditional electromagnetic generators. Modern PMGs have found favor in harsher environments where wind or water may be an issue, e.g., with wind turbines or for pumps on levees or dams. Since PMGs do not need a direct current (DC) source (battery) for excitation of the circuit, they are useful in remote locations or when other power sources are unavailable. PMGs are also environmentally friendly as they produce no harmful waste and can reduce the environmental pollution impact of electricity generation by 50% or more over traditional fossil fuel driven generators.

As PMGs offer certain advantages in the production of electricity, there continues to be a need for improved devices that have larger, more reliable, electrical output. The PMG as described herein uses a novel permanent magnet arrangement to produce rotational energy to drive a conductor within a permanent magnetic field to generate reliable energy. The generator as described may be used in combination with other power generators, e.g., turbines or motors, so it may be used alone to provide small to large electrical output needs.

### SUMMARY OF THE INVENTION

The disclosure describes a magnetic rotor for a permanent magnet generator for producing electrical output. The disclosure further describes a generator assembly including a rotating permanent magnetic assembly to spin a conductor made up of a wire winding within a stator assembly including a second set of permanent magnetics. The disclosure further describes a method of arranging permanent magnetics in a magnetic rotor to provide rotational energy to a conductor to achieve improved power output.

According to one embodiment, the disclosure describes a generator for producing electrical output from permanent magnets comprising, a rotor assembly including an insulating base comprising mounts for attaching at least ten magnetic elements, wherein at least five of the ten magnetic elements are primary elements and at least five of the 10 magnetic elements are secondary elements; the at least five primary magnetic elements comprising a core for coupling the magnetic elements to the mount, each primary magnetic element having a least five arms each having a first end and a second end, wherein the first end of each arm is attached to the core and the second end comprises a permanent magnet, the at least five secondary magnetic elements comprising a core for coupling the magnetic elements to the mount, each secondary magnetic element having a least five arms each having a first end and a second end, wherein the first end of each arm is attached to the core and the second end comprises a permanent magnet, wherein a primary magnetic element is mounted adjacent each secondary magnetic element; and wherein a conductor assembly for collecting electrical output is attached to at least one magnetic element; and wherein the conductor assembly is the a stator and includes at least two permanent magnets that create a magnetic field within which the conductor rotates.

In yet another embodiment, the present disclosure describes a method of generating an electrical output from permanent magnets comprising, arranging a series of magnetic elements in circular relationship wherein the first magnet on the first magnetic element pushes the first magnet on the second magnetic element causing the magnets to spin generating a rotational energy; coupling a conductor to at least one of the magnetic elements; and spinning the conductor in a second magnetic field to generate current.

According to yet another embodiment, the present disclosure describes a permanent magnet rotor for a permanent magnet generator comprising, a base; and a magnetic assembly comprising, at least four magnetic elements, at least two being primary elements and at least two being secondary elements wherein each magnetic element comprising at least three arms, each arm comprising at least one permanent magnet.

A better understanding of the various disclosed system and method embodiments can be obtained when the following detailed description is considered in conjunction with the drawings.

### BRIEF DESCRIPTION OF THE DRAWINGS

FIG. 1 is a top perspective view of a base for a rotor for holding permanent magnetic elements.

FIG. 2 is a top view of 10 magnet elements for mounting on the rotor base of FIG. 1.

FIG. 3 is a top plan view of a single magnetic element of FIG. 2.

FIG. 4 is a partial side view of the magnetic assembly including at least one conductor.

FIG. 5 is a partial size view of the magnetic assembly including an assembly housing.

FIG. 6 is a plan view of a cooling system which may be used to cool the magnetic assembly.

FIG. 7 illustrates one embodiment of a conductor and permanent magnetic stator for use with the magnetic assembly.

FIGS. 8A and 8B illustrate permanent magnets and permanent magent housings as found on the arms of the magnetic elements.

FIGS. 9A and 9B illustrate a braking system for use with the PMG as described.

FIG. 10 illustrates a magnetic assembly of FIG. 2 exemplifying one set of relative magnetic flux densities and magnetic pole positions.

FIG. 11 is a partial side view of the magnetic assembly with a plurality of stacked magnetic elements.

FIG. 12 is a partial side view of the magnetic assembly, conductor and housing in a stacked assembly.

The drawing figures are not necessarily to scale. Certain features of the embodiments may be shown exaggerated in scale or in somewhat schematic form and some details of conventional elements may not be shown in the interest of clarity and conciseness.

### DESCRIPTION

The following discussion is directed to various embodiments of the invention. Although one or more of these embodiments may be preferred, the embodiments disclosed should not be interpreted, or otherwise used, as limiting the scope of the disclosure, including the claims. It is to be fully recognized that the different teachings of the embodiments discussed below may be employed separately or in any suitable combination to produce desired results. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not structure or function.

In the following discussion and in the claims, the terms “including,” “comprising,” and “is” are used in an open-ended fashion, and thus should be interpreted to mean “including, but not limited to.”

As used herein, the terms “permanent magnet generator” refers to a system that uses the rotor configuration of magnets as described herein. “PMG,” “permanent magnet generator,” and “magnetic generator” as used herein all refer to the described “permanent magnet generator” unless clearly indicated otherwise.

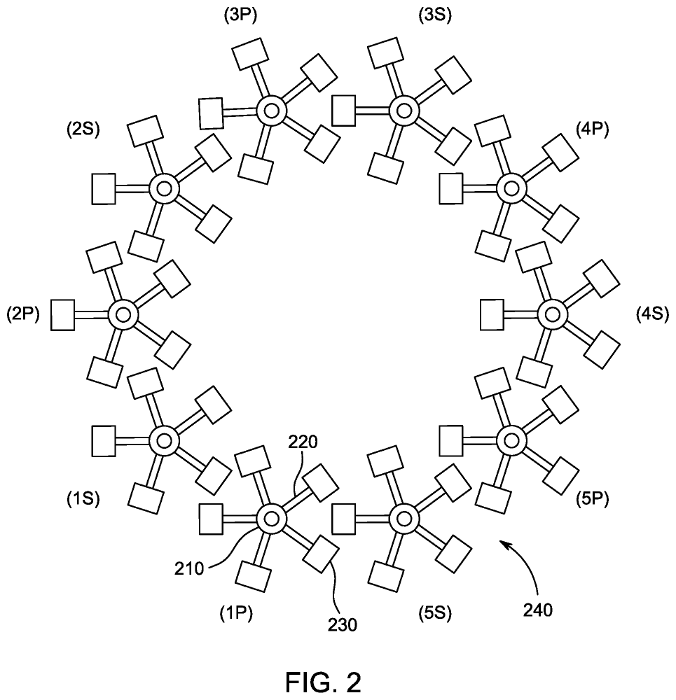

PMGs as described herein are made up of a rotor and a stator. In ordinary PMGs, either the rotor or the stator carries a magnetic assembly and the other includes the conductor assembly/armature. In one embodiment as described in the instant application, both the rotor and the stator rely on permanent magnets. In this embodiment, the rotor comprises one or more magnetic assemblies as seen in FIG. 2 that comprise a plurality of magnetic elements that rotate. According to this embodiment, the magnetic assembly is part of a rotating armature that carries the electromotive force. Specifically, the rotating magnetic elements are coupled to at least one conductor assembly that is made up of one or more core elements that are capable of generating the appropriate electrical output or which have been wrapped with conductive wire that is capable of generating the appropriate electrical output. The conductor assembly may be any art recognized assembly, for example, the output may be a single or three phase output winding. The magnetics assembly rotation causes the conductor assembly to spin. The spinning conductor assembly is placed proximate at least two permanent magnetics that make up the stator assembly. The movement of the spinning conductor within the magnetic field induces the production of electricity.

As used in this context, proximate means that the stator assembly is located in a position relative to the rotating conductor assembly such that the conductor assembly interacts with the magnetic field and produces electricity. The positioning of the armature and magnetic field generator is well understood in the art of PMGs and the elements may have air gaps or be in direct contact with one another, as desired.

The conductor assembly creates electromotive force as an output voltage which may be captured or used immediately. The output voltage may be controlled by a voltage regulator which can be powered by the electrical output generated by the conductor assembly.

The magnetic assembly that forms part of the rotor assembly, described below, includes a number of permanent magnetics arranged on or integral with magnetic elements that are combined to cause the magnetic assembly to rotate. The stator also uses permanent magnets to generate the magnetic field within which the conductor assembly spins. While different types of permanent magnets are available, any art recognized magnet or magnetic material may be used in either the magnetic assembly of the rotor or the stator. Materials for fabrication of the permanent magnets for use in the system as described may be chosen from any art recognized permanent magnets, including, but not limited to iron, cobalt, aluminum, nickel, Alnico, Sm—Co, rare earth element based permanent magnets and combinations thereof. Rare earth permanent magnets may be chosen from R-T-B rare earth magnets, R—Fe—B permanent magnetics, Nd—Fe—B permanent magnets. The use of permanent magnets as described provides a cost effective, environmentally stable, compact alternative PMG as described herein.

Unlike an electromagnet which has no magnetic field when the power that drives the magnet is ended, permanent magnets continuously exhibit a magnetic field. Depending upon the size and strength of the PMG being considered, the PMG as described herein may included magnets that are not initially charged. Such a configuration may provide advantages given current limitations on shipping and working with magnetic materials. According to this embodiment, the permanent magnets may be charged once the generator has been placed into its final working position. Permanent magnets are routinely charged using a pulse of electrical current. According to another embodiment, the generator may include an electrical charger for magnetizing the permanent magnets to the desired magnetic flux density once the PMG as described, has been installed. Such a charger may be operated by connection to an electrical source or may be powered by a battery.

One embodiment of a PMG of the instant disclosure will be described with reference to the Figures.

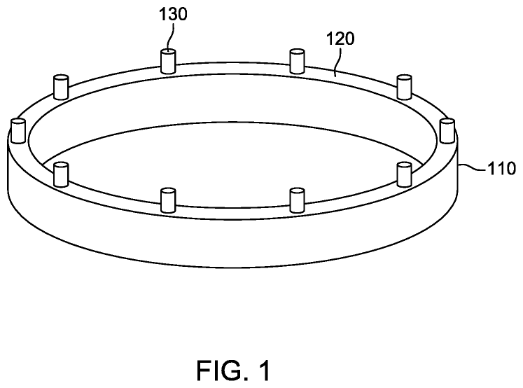

According to one embodiment, as seen in FIG. 1 a base 110 is provided for holding ten magnetic elements, as seen in FIG. 2. The base 110 is comprised of a holding member 120 that includes a plurality of posts 130 that extend upward from the holding member 120. While this embodiment shows posts 130 for guiding the magnetic elements 220, alternative guides are contemplated and are appropriate so long as they act as a support to maintain the magnetic assemblies in the correct relative locations. The base 110 and holding member 120 may be made from any art recognized material so long as the material does not interfere with the operation/rotation of the magnetic assembly. Any art recognized non-conductive or low-conductivity materials may be considering, including for example, plastics, non-conductive polymers, glass, rubber, ceramic, titanium, stainless steel, carbon fiber and the like or combinations thereof. Further, materials may be chosen from conductive materials that have been treated or coated to insulate them.

According to one embodiment, FIG. 2 illustrates 10 magnetic elements 240 each including a ring 210, a series of arms 220, either attached to the ring 210 or integral with the ring 210, and a permanent magnet 230. The magnetic elements 240 as shown can be loaded onto the plurality of posts 130 as seen in FIG. 1. As seen in FIG. 2, five of the magnetic elements have been designated as primary elements (1P, 2P, 3P, 4P, 5P) and five have been designated as secondary elements (1S, 2S, 3S, 4S, 5S). Each of the primary elements (1P, 2P, 3P, 4P, 5P) is bounded by a pair of secondary elements (1S, 2S, 3S, 4S, 5S). The designation of primary and secondary elements defines the manner and order in which the permanent magnets 230 are charged. As used herein “charging” of the magnet refers to magnetizing the magnetic material to the desired magnetic flux density. A detailed description of how to charge each of the primary and secondary magnetic elements is provided in Example 1, below.

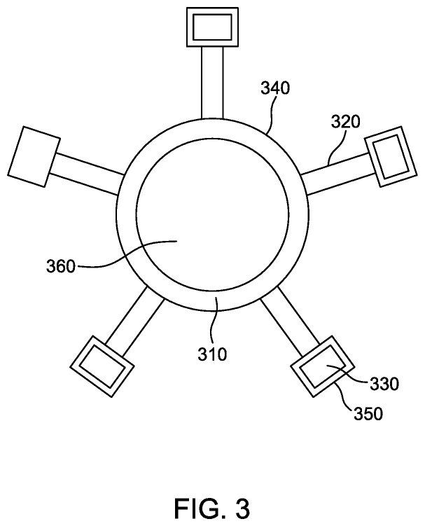

According to one embodiment, FIG. 3 illustrates a single magnetic element 340, as seen in FIG. 2. The element 340 includes a ring 310, a plurality of arms 320, a plurality of permanent magnets 330, a plurality of magnet housings 350, and an aperture 360. The aperture 360 associates with one of the plurality of posts 130 as seen in FIG. 1 in any manner which allows the rotation of the magnetic element 340. The attachment may be comprised of any art recognized means of facilitating rotation, including for example ball bearings, cylindrical roller bearings, tapered roller bearings, use of lubricants such as oilite, Teflon, boron nitride and the like, or combinations thereof so long as the manner of attachment and material does not interfere with the operation of the magnetic element or the magnetic assembly. While the exemplified embodiment show the arms attached to a ring with a central aperture, the configuration of the center of the magnetic element may be changed to any configuration that coordinates with associated holder. For example, the center may be a fructo-conical shape that sits upon the top of the post. Art recognized configurations for mating the holder and the magnetic elements are fully contemplated within this disclosure.

On the other end of the arms 320 are the permanent magnets for creating rotation. The plurality of magnet housings 350 are each either attached or integral to one of the plurality of arms 320. The plurality of arms 320 and the plurality of magnet housings 350 may be made from any art recognized material so long as the material does not interfere with the operation of the magnetic assembly, including any art recognized non-conductive, low-conductivity or modified conductivity materials, e.g., materials that have been treated or coated to insulate them. Each arm 320 may have one or more magnetics which may include a magnetic housing 350 or may not. In addition, the magnetic housings 350 on each arm 320 may be the same or different.

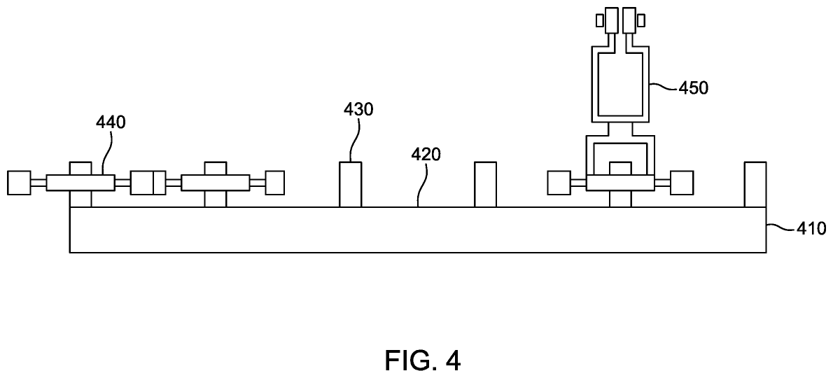

According to another embodiment, FIG. 4 Illustrates a holding member 410 having a base 420 and a plurality of posts 430 as seen in FIG. 1. A plurality of magnetic elements 440 as seen in FIG. 3 are attached to the plurality of posts 430 in a manner that facilitates rotation of the magnetic elements 440. In one embodiment, one of the at least one conductor assemblies 450 is attached to one of the plurality of magnetic elements 440. The at least one conductor assembly 450 also functions as the armature within the generator. Any art recognized armature may be used, including for example lap patterns or wave patterns, ones with single phase winding, ones with poly phase winding, ones with concentrated winding, ones with distributed winding, ones with single layer winding, ones with double layer winding or the like, or any combination thereof. According to one embodiment, each magnetic element 440 includes a conductor assembly 450.

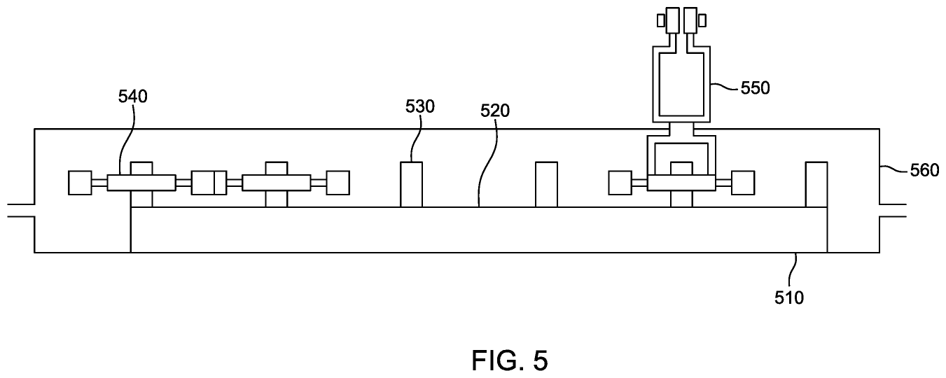

According to one embodiment, FIG. 5 Illustrates a holding member 510, as seen in FIG. 4, within a housing 560. In one embodiment, the housing 560 is designed to prevent or significantly limit the flow of matter (e.g., coolant, magnetic field energy, etc.) between the interior and exterior of the housing except through designated entrances and exits. The holding member 510 comprises a base 520 and a plurality of posts 530 attached to a plurality of magnetic elements 540 in a manner that facilitates their rotation. The plurality of conductive assemblies 550 are each coupled to one of the magnetic elements 540. The conductive assemblies 550 and the magnetic elements 540 can be coupled in any art recognized manner.

In one embodiment, the conductor assemblies 550 are located within the same housing as the magnetic elements 540. In this embodiment, the rotating magnetic assembly and the magnetic stator assemblies need to be sufficiently separated to prevent field interference between the magnets. According to another embodiment, the conductor assemblies are contained with a separate housing, not shown. According to this embodiment, the housing may be insulated and cooled in the same manner as the housing for the rotating magnetic assembly. In yet another embodiment, the conductor assemblies 550 are outside of the housing 560. In embodiments where the plurality of conductor assemblies 550 have elements outside of the housing 560, the housing 560 is designed in a manner that prevents flow of material from the interior of the housing 560 to the exterior via the conductor assemblies 550 exits. The housing 560 may be constructed of any heat insulating material recognized in the art, including for example polystyrene, fiberglass, polyurethane foam and the like, or any combination thereof so long as it does not interfere with the operation of the magnetic assembly.

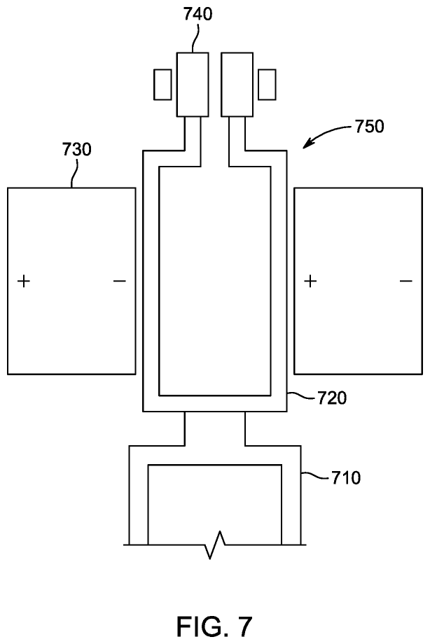

According to one embodiment, the conductor assemblies 550 are located in a separate housing from the magnetic elements 540. According to this embodiment, the two housings are separated by an insulator that prevents overlap and interference of the magnetic fields generated by the magnetic elements 540 and the permanent magnets that make up the stator and which surround the rotating conductor assembly 550. While the permanent magnet stator is not seen in this figure, the permanent magnet stator assembly can be seen in FIG. 7.

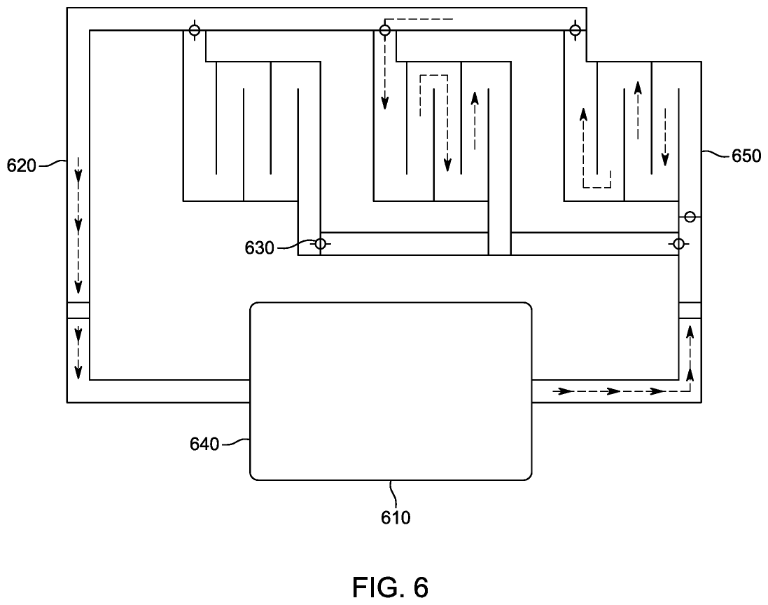

According to one embodiment, FIG. 6 illustrates a cooling system 620 that may be attached to the generator 610. The cooling system as described by be applied to the rotor assembly, the stator assembly or to any one of them selectively. The cooling system may also be applied to any housing, fully or partially, as desired. In one embodiment, the cooling system 620 creates a flow of coolant into and out of the housing 640. The housing 640 can be the housing 560 as seen in FIG. 5 or can be the housing for conductor assemblies 550, which is not shown or can be any partial or full combination thereof. In one embodiment the coolant flow is directed via a plurality of valves 630 through a plurality of compartments 650. These compartments 650 allow portions of the coolant to return to proper temperature before being recycled back into the cooling system 620. The redundant nature of the cooling system may allow sufficient heat removal from the generator using environment air; however, the coolant can be any art recognized coolant, including for example air, hydrogen, freon, sulfur hexafluoride, two phase coolants, water, polyalkylene glycol, and the like or any combination thereof so long as it does not interfere with the operation of the magnetic assembly.

According to one embodiment, FIG. 7 illustrates the conductor assembly 750 as seen in FIG. 5, and the stator 730. In one embodiment, the conductor assembly 750 comprises a non-conductive mount 710. The mount may be constructed from any non-electrically conductive material recognized in the art, including for example porcelain, glass, rubber, wood, the like or any combination thereof. According to the embodiment shown, the mount is attached to a conductive wire 720. While the conductive assembly is shown as a simple wire 720 it may be chosen from any art recognizes conductors or armatures as discussed above. It may be constructed from any conductive material recognized in the art, including for example copper or aluminum.

On either side of the wire are a plurality of permanent magnets 730 that make up the stator. Typically permanent magnet assemblies include a number and configuration of magnets that is selected to provide the best electrical output based upon the wire winding configuration used. The permanent magnets 730 can be any art recognized permanent magnets in any art recognized magnet configuration, including for example Alnico magnets, neodymium magnets, samarium-cobalt magnets, the like or any combination thereof. In one embodiment the wire 720 can be connected to a commutator 740 to convert alternating current to direct current. While FIG. 7 illustrates a split ring commutator, any art recognized configuration may be used.

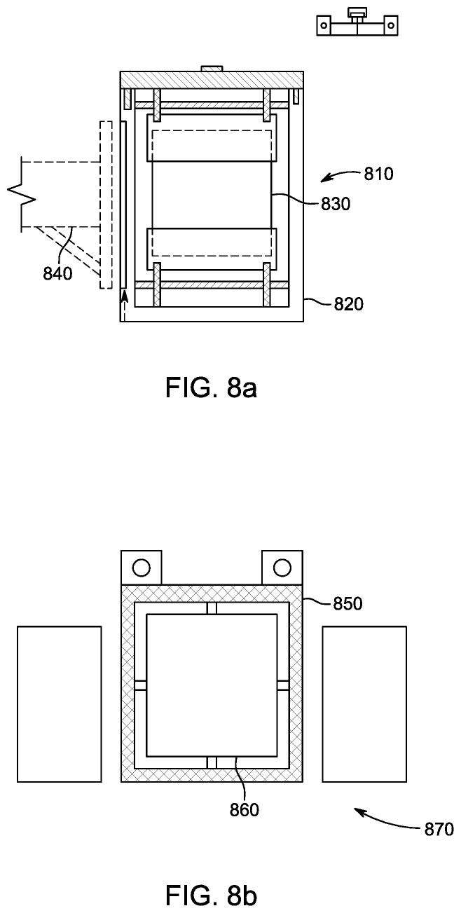

According to one embodiment, FIG. 8a illustrates a cut away view of a permanent magnet in a housing 810 on the arm of the magnetic element seen in FIG. 3. The housed magnet 810 comprises a housing 820 surrounding a permanent magnet 830. The housing can be constructed of any electrical or magnetic insulator recognized in the art. The magnet may be any permanent magnet recognized in the art. The housing 820 is attached to or is integral to an arm 840 which attaches the magnet to the magnetic element 340 as seen in FIG. 3.

FIG. 8b shows an alternative magnet housing embodiment 870 that comprises a magnetic housing 850 and a permanent magnet 860. Again, the housing 850 is attached to or is integral to an arm which attaches the magnet to the magnetic element 340 as seen in FIG. 3.

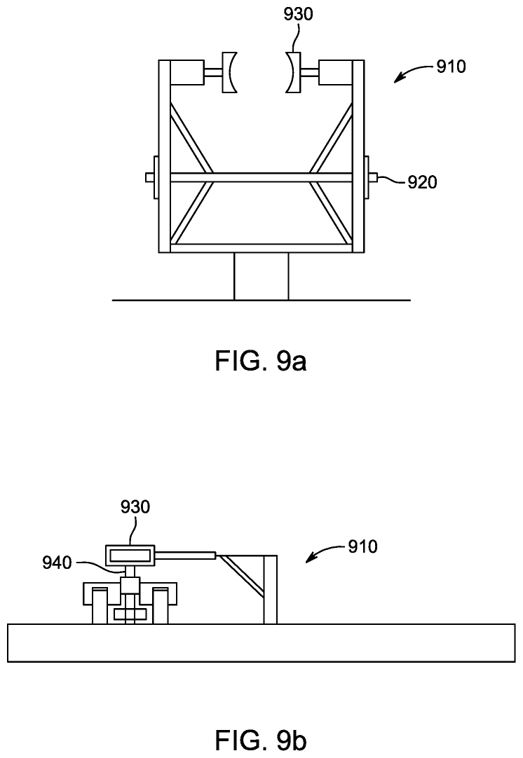

To prevent continuous rotation of the magnetic assembly in the PMG as described, a braking assembly is used to hold one or more magnetic elements and prevent the rotation of the magnetic assembly. In one embodiment, FIG. 9A illustrates a top down view of a breaking assembly 910. The breaking assembly 910 comprises at least one hydraulic motor 920 and a plurality of brake pads 930. The plurality of brake pads 930 can be any art recognized brake pads, including for example semi-metallic, non-asbestos organic, low-metallic NAO, ceramic, and the like, or any combination thereof. The at least one hydraulic motor 920 can be any art recognized hydraulic motor, including for example a vane motor or a gear motor.

FIG. 9B illustrates the breaking assembly 910 as seen in FIG. 9a from a side view. The plurality of brake pads 930 surround an arm 940. The arm 940 is attached or integral to a magnetic element 340 as seen in FIG. 3. The arm 940 can be attached to the magnetic assembly in any manner through which halting the rotation of the arm 940 would in turn halt the rotation of the magnetic assembly. The at least one hydraulic motor 920 is attached to the plurality of brake pads 930 in a manner that causes the brake pads 930 to press against the arm 940 when the motor is activated. The brake pads 930 rapidly increase the friction experienced by the arm 940 bringing the magnetic element to a halt and in turn bringing the system to a halt by stopping the magnetic assembly.

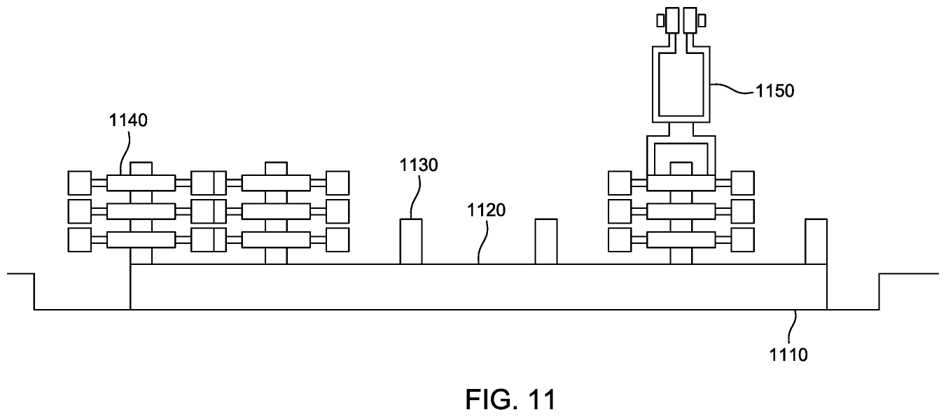

According to one embodiment, FIG. 11 illustrates a holding member 1110 having a base 1120 and a plurality of posts 1130 consistent with those as seen in FIG. 1. In the embodiment shown multiple elements 1140 are attached to each of the plurality of posts 1130 in a manner that facilitates rotation of the magnetic elements 1140. The embodiment shown includes three magnetic elements 1140 attached to each post 1130. The combination of magnetic elements 1140 can provide more power to the magnetic assembly allowing it to generate higher amounts of electricity. As shown, one of the at least one conductor assemblies 1150 is attached to at least one of the plurality of magnetic elements 1140. According to one embodiment, each magnetic element 1140 includes a conductor assembly 1150.

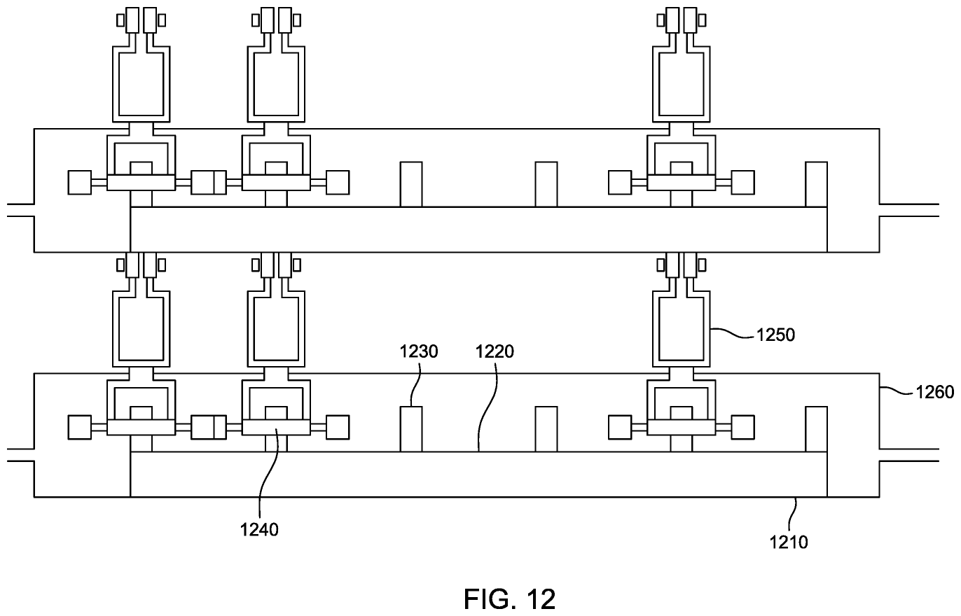

According to another embodiment as seen in FIG. 12 the housing 1260 including the magnetic elements 1240, associated base 1220 and posts 1230, and conductor assembly 1250 may be stacked on upon another to generate higher amounts of electricity. In the embodiment shown, the conductor assembly is not encased in a separate housing, however, when stacking assemblies, the conductor assemblies will be contained within a separate housing that allow the electricity to be generated and collected. According to one embodiment, a stacked assembly further comprises a conductive carrier assembly for collecting the electricity from the various conductor assemblies and carrying that electricity to use or storage. As shown, three of the conductor assemblies 1150 are attached to magnetic elements 1140. According to one embodiment, each magnetic element 1240 includes a conductor assembly 1250.

The permanent magnetic generator as described herein can provide consistent output that may be accumulated by a battery or a current collector making the energy available via any art recognized electrical grid. The permanent magnetic generator may include one or more accessories necessary for its commercial operation. Typical magnetic generators are housed in appropriate commercial housing that typically include transfer switches, breakers, LCD or other user displays, electrical or battery connections.

The system as described may comprise one or more commutators to convert alternating current into direct current. Commutators for use in the described system can include a rotary electrical switch that periodically reverses the current direction between the conductor assembly and the external, and the like.

Housings for use with the generator as described include all weather, or metallic overframes. Typical housing including a base portion that may be used internal or external to a structure. When used externally, the base typically sits on a composition pad, but it can sit directly on soil. The housing will have at least one vented opening for cooling, if the unit is air cooled, or will have appropriate flow controls if a cooling unit as described in FIG. 6 is used in association with the housing or any part of the generator.

Permanent magnets are heat sensitive and the application of heat can cause a reduction in magnetism. Upon cooling, full magnetism may be restored. The magnetic assembly as described herein may avoid degradation of its magnetic strength by the application of the coolant to remove heat, or by other means to prevent heat from developing in the system. According to one embodiment, the magnetic assembly is maintained at about room temperature. If the magnetic materials become too hot or are demagnetized by coercivity or shock, the magnets may be remagnetized to restore the desired level of charge. According to one embodiment, the magnets may be periodically recharged to maintain optimal performance.

### EXAMPLES

### Example 1

One rotor configuration that provides the mechanical energy that can rotate the conductor assembly as described includes ten magnetic elements each comprised of five permanent magnetics that together form one magnetic assembly. The assembly is made up of ten magnetic elements, five of which are primary elements, and five of which are secondary elements. See FIG. 2. The bottom most magnetic element is designated as the first primary element (1P). Moving clockwise around the construction we arrive at the first secondary element (1S), element (2P), element (2S) element (3P) . . . etc until arriving back at the first primary element (1P).

A elements designation as primary or secondary determines the values of the charges of the five permanent magnets attached to it. Primary elements have charge values following the following formulas:

The first magnet has a charge value of X+1, where X can be any desired charge. The second magnet moving clockwise has a value of X+3. The third magnet has a value of X+5. The fourth magnet has a value of X+7. And the fifth and final magnet has a value of the sum of the previous four magnets, 4X+16

The secondary elements have values of X, X+2, X+4, X+6, and 4X+12. However, the values of the secondary elements are arranged in the counter-clockwise direction.

In addition, the direction of the magnet's poles are arranged in a very specific fashion. On every element, the arrangement alternates between magnets. So, if the first magnet is positive on the left, negative on the right, the second magnet will be negative on the left and positive on the right, the third magnet will return to positive negative, and so on. This means that the fifth and first magnets will have the same orientation. For odd primary elements, the X+1 magnet is arranged so the positive pole is on the left and the negative pole is on the right. For even primary elements, the X+1 magnet is arranged so the negative pole is on the left and the positive pole is on the right.

For all secondary elements, the X valued magnets have the negative pole on the right, and the positive pole on the left. Magnets again alternate their orientation, however consecutive magnets are now found by moving in the counter-clockwise direction.

### Example 2

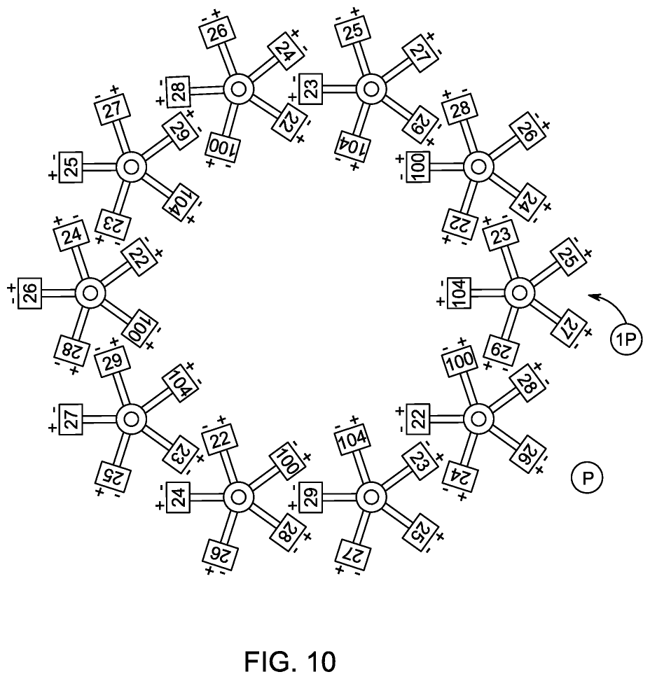

One magnetic assembly including the relative changes of the magnetics along with the pole positions is shown in FIG. 10. Ten magnetic assemblies 10 are illustrated, each bearing five magnets 20. Each of these five magnets is labeled with a value. These values are a measure of the magnetic flux density in centitesla. The magnetic element labelled (1P) is the first primary element of the system. The primary and secondary magnetic element designations as well as their numbering are provided in FIG. 2. Starting from the 23 cT magnet and moving clockwise around the magnetic element, the magnets of the first primary element have magnetic flux densities of 23 cT for the first magnet, 25 cT for the second magnet, 27 cT for the third magnet, 29 cT for the fourth magnet, and 104 cT for the fifth magnet. Each of the magnets is also labeled with a plus sign corresponding to the south pole of the magnet and a minus sign corresponding to the north pole of the magnet. The first magnet has its south pole on the right and its north pole on the left. As you move clockwise around the first primary magnetic assembly each magnet will reverse the positions of its poles, so that the second magnet will have its north pole on the right and its south pole on the left, the third magnet will have its south pole on the right and its north pole on the left, and so on. All odd primary wheels, (1P), (3P) and (5P) have identical magnetic flux density arrangements and identical arrangements of the magnetic poles.

Moving clockwise from the first primary magnetic element will lead to the first secondary magnetic element. All secondary magnetic elements will have the exact same lay out. Magnets will have charges of 22 cT, 24 cT, 26 cT, 28 cT, and 100 cT. These values ascend counterclockwise around the magnetic element. The arrangement of magnetic poles within the secondary magnetic elements is also consistent across all secondary magnetic elements. The 22 cT magnet will have north pole on the right, and the south pole on the left when viewed from above. Moving counter-clockwise around the magnetic elements the 24 cT magnet will have the south pole on the right and the north pole on the left, the 26 cT magnet will have the north pole on the right and the south pole on the left, and so on.

Continuing clockwise around the generator from the first secondary magnetic element leads to the second primary magnetic element. The even primary elements, (2P) and (4P), have the same layout of magnetic flux densities and the same layout of magnetic poles. Starting at the 23 cT magnet and moving clockwise around the assembly will lead to a 25 cT magnet, a 27 cT magnet, a 29 cT magnet, and a 104 cT magnet as seen in the odd primary elements. The difference now is the arrangement of magnet poles in the even primary elements is the inverse of the odd primary elements. In the second primary element, the 23 cT magnet has a south pole on the left and a north pole on the right. The 25 cT magnet has a north pole on the left and a south pole on the right. The 27 cT magnet has a south pole on the left and a north pole on the right. And so on.

### Example 3

In another embodiment the magnetic assembly comprises six magnetic elements. The six magnetic elements are designated in clockwise order first primary (1P), first secondary (1S), second primary (2P), second secondary (2S), third primary (3P), and third secondary (3S). Each magnetic element comprises five permanent magnets with a specific distribution of magnetic flux density and arrangement of magnetic poles. The secondary magnetic elements all have the same arrangement of magnetic poles and distributions of magnetic flux density. The ratio of magnetic flux density values are found moving counter clockwise around the secondary magnetic elements, and in order are 22 to 24 to 26 to 28 to 100. The arrangement of magnetic poles is as follows: on the 22 magnet has the north pole on the left, the south pole on the right. The poles then alternate counterclockwise around the magnetic element: the 24 magnet has the south pole on the left, the north pole on the right, the 26 magnet has the north pole on the left, the south pole on the right, and so on.

The primary magnetic elements are divided into even and odd primary elements. Both have the same distribution of magnetic flux densities but have opposing arrangements of magnetic poles. In both cases, the ratio of magnetic flux density values of the five magnets, moving clockwise around the element, is 23 to 25 to 27 to 29 to 104.

In the case of the odd primary magnetic element, the arrangement of magnetic poles begins at the 23 magnet which has the north pole on the left and the south pole on the right. The magnets then alternate the pole positions as you move clockwise around the assembly. The 25 magnet has the south pole on the left and the north pole on the right, the 27 magnet has the north pole on the left and the south pole on the right, and so on.

In the case of even primary magnetic elements, the arrangement of magnetic poles is the inverse of the odd primary wheels. The 23 magnet has the south pole on the left and the north pole on the right, the 25 magnet has the north pole on the left and the south pole on the right, the 27 magnet has the south pole on the left and the north pole on the right, and so on.

### Example 4

In another embodiment the magnetic assembly comprises four magnetic elements. Each of the four magnetic elements comprises three magnets. Moving clockwise around the system the wheels are designated first primary (1P), first secondary (1S), second primary (2P), and second secondary (2S). Each magnetic element has a specific arrangement of magnetic poles and ratio between the values of the three magnets magnetic flux density.

The secondary magnetic elements both have the same arrangement of magnetic poles and ratios of magnetic flux density. For both magnetic elements, the ratio of the magnetic flux densities moving counter-clockwise around the wheels is 22 to 24 to 46. The 22 magnet has a north pole on the left, and a south pole on the right. The magnets then alternate the position of the poles moving counter clockwise around the assemblies, so that the 24 magnet has a south pole on the left and a north pole on the right, and the 46 magnet has a north pole on the left and a south pole on the right.

The first primary magnetic element and second primary magnetic element have the same ratio of magnetic flux densities. For both primary elements the ratio of the magnetic flux densities moving clockwise around the element is 23 to 25 to 48. The first and second primary magnetic elements have opposing arrangements of magnetic poles. For the first primary element, the 23 magnet has the north pole on the left and the south pole on the right, the 25 magnet has the south pole on the left and the north pole on the right, and the 48 magnet has the north pole on the left and the south pole on the right. For the second primary element, the 23 magnet has the north pole on the left and the south pole on the right, the 25 magnet has the south pole on the left and the north pole on the right, and the 48 magnet has the north pole on the left and the south pole on the right.

### Example 5

According to another embodiment as described herein, the magnetic assembly as seen in FIG. 2 may alternatively be used as the rotor creating a changing magnetic field. In this embodiment, the ring of magnets as seen in FIG. 2 further comprises a stationary stator that may be fitted into the center of the magnetic ring. In this embodiment, the stator may be any appropriate conductor assembly, for example a copper winding that takes the form of a donut. In this embodiment, the stator may be located in the center of the base 110 as seen in FIG. 1. The spinning magnetic elements 240 from FIG. 2 would create the changing magnetic field that would interact with the conductor assembly thereby creating electricity. According to one embodiment, the stationary stator may be an elongated conductor assembly that may interact with more than one of the magnetic assemblies in a stack, e.g., such as the stack shown in FIG. 11.

While this embodiment hasn't been exemplified within the drawings, once the skilled artisan constructs the rotating magnetic assembly, appropriate selection and placement of conductor assemblies (in this embodiment—stationary stators), would be readily apparent.

Other embodiments of the present invention can include alternative variations. These and other variations and modifications will become apparent to those skilled in the art once the above disclosure is fully appreciated. It is intended that the following claims be interpreted to embrace all such variations and modifications.

I claim:

1. A generator for producing electrical output from permanent magnets comprising:
a rotor assembly comprising:
a magnetic assembly comprising
an insulating base comprising mounts for attaching at least one magnetic element;
at least five primary magnetic elements comprising a core for coupling the magnet element to the mount, each secondary magnet element having a least five arms each having a first end and a second end wherein the first end of each arm is attached to the core and the second end comprises a permanent magnet;
at least five secondary magnetic elements comprising a core for coupling the magnet element to the mount, each secondary magnet element having a least five arms each having a first end and a second end wherein the first end of each arm is attached to the core and the second end comprises a permanent magnet;
wherein a primary magnetic element is mounted adjacent each secondary magnetic element; and
a conductor assembly attached to at least one of the magnetic elements, wherein the magnetic element rotates the conductor assembly; and
a stator assembly comprising:
at least two permanent magnetics surrounding the conductor assembly.

2. The generator of claim 2, wherein the first primary element (1P) is adjacent the first secondary element (1S) moving in the clockwise direction, which is adjacent to element (2P) in the clockwise direction, which is adjacent to, element (2S) in the clockwise direction, which is adjacent element (3P), which is adjacent to element (3S) in the clockwise direction, which is adjacent to element (4P) in the clockwise direction, which is adjacent to element (4S) in the clockwise direction, which is adjacent to element (5P) in the clockwise direction, which is adjacent to element (5S) in the clockwise direction, which is adjacent to element (1P) in the clockwise direction.

3. The generator of claim 1, wherein the five permanent magnets on the primary magnetic elements are charged as follows:
the first magnet has a charge value of X+1, where X can be any desired charge, moving clockwise, the second magnet has a value of X+3, the third magnet has a value of X+5, the fourth magnet has a value of X+7, and the fifth magnet has a value of the sum of the previous four magnets, 4X+16.

4. The generator of claim 1, wherein the five permanent magnets on the secondary magnetic elements are charged as follows:
the first magnet has a charge value of X, where X can be any desired charge, moving counter-clockwise, the second magnet has a value of X+2, the third magnet has a value of X+4, the fourth magnet has a value of X+6, and the fifth magnet has a value of the sum of the previous four magnets, 4X+12.

5. The generator of claim 1, wherein the direction of the magnetic poles on each permanent magnetic are reversed.

6. The generator of claim 2, wherein the odd primary magnetic elements, the X+1 magnet is arranged so the positive terminal is on the left and the negative poles is on the right and for even primary elements, the X+1 magnet is arranged so the negative pole on the left and the positive is on the right.

7. A method of generating an electrical output from permanent magnets comprising;
arranging a series of magnetic elements in circular relationship wherein the first magnet on the first magnetic elements pushes the first magnet on the second magnetic element causing the magnets to spin;
coupling a conductor assembly to at least one rotating magnetic element;
subjecting the conductor assembly to a separate magnetic field and generating electrical output.

8. The method of claim 7, wherein the series of magnetic elements comprises
at least four magnetic elements, at least two being primary elements and at least two being secondary elements wherein each magnetic element comprising at least three arms, each arm comprising at least one permanent magnet
wherein the permanent magnets on the primary magnetic elements are charged as follows:
the first magnet has a charge value of X+1, where X can be any desired charge, moving clockwise, the second magnet has a value of X+3, the third of the sum of the previous two magnets, 2X+4; and
wherein the three permanent magnets on the secondary magnetic elements are charged as follows:
the first magnet has a charge value of X, where X can be any desired charge, moving counter-clockwise, the second magnet has a value of X+2, the third magnet has a value of the sum of the previous two magnets, 2X+2.

9. The method of claim 8, wherein the series of magnetic elements comprise at least six magnetic elements, three primary and three secondary and wherein each magnetic element comprises at least 5 arms.

10. A permanent magnet rotor for a permanent magnet generator comprising:
a base; and
a magnetic assembly comprising
at least four magnetic elements, at least two being primary elements and at least two being secondary elements wherein each magnetic element comprising at least three arms, each arm comprising at least one permanent magnet
wherein the permanent magnets on the primary magnetic elements are charged as follows:
the first magnet has a charge value of X+1, where X can be any desired charge, moving clockwise, the second magnet has a value of X+3, the third of the sum of the previous two magnets, 2X+4; and
wherein the three permanent magnets on the secondary magnetic elements are charged as follows:
the first magnet has a charge value of X, where X can be any desired charge, moving counter-clockwise, the second magnet has a value of X+2, the third magnet has a value of the sum of the previous two magnets, 2X+2.

11. The rotor of claim 10, wherein the series of magnetic elements comprise at least six magnetic elements, three primary and three secondary and wherein each magnetic element comprises at least five arms.

12. The rotor or claim 10, wherein the series of magnetic elemetns comprises at least ten magnetic elements, five primary and five secondary and wherein each magnetic element comprises at least five arms.
